(19) United States
(12) Patent Application Publication
(10) Pub. No.: US 2025/0210271 A1
(43) Pub. Date: Jun. 26, 2025

(54) MULTILAYER CERAMIC CAPACITOR

(71) Applicant: SAMSUNG ELECTRO-MECHANICS CO., LTD., Suwon-si (KR)

(72) Inventors: Byungwoo Kang, Suwon-si (KR); Jungmin Kim, Suwon-si (KR); Seung-Hun Han, Suwon-si (KR); Hyejin Park, Suwon-si (KR); Sangwook Lee, Suwon-si (KR)

(73) Assignee: SAMSUNG ELECTRO-MECHANICS CO., LTD., Suwon-si (KR)

(21) Appl. No.: 18/673,506

(22) Filed: May 24, 2024

(30) Foreign Application Priority Data
Dec. 20, 2023 (KR) 10-2023-0187437

(51) Int. Cl. H01G 4/232; H01G 4/248; H01G 4/30

(52) U.S. Cl. CPC H01G 4/2325; H01G 4/248; H01G 4/30

(57) ABSTRACT

A multilayer ceramic capacitor includes a ceramic body including a plurality of first internal electrodes and a plurality of second internal electrodes disposed inside the ceramic body, and a first external electrode and a second external electrode disposed outside the ceramic body. The first external electrode includes a first end portion electrically connected to the plurality of first internal electrodes, a first side portion extending from the first end portion, and a first conductive resin layer covering at least a portion of the first side portion, and the second external electrode includes a second end portion electrically connected to the plurality of second internal electrodes, a second side portion extending from the second end portion, and a second conductive resin layer covering at least a portion of the second side portion, and wherein the first conductive resin layer and the second conductive resin layer include tin (Sn) and bismuth (Bi).

### CROSS-REFERENCE TO RELATED APPLICATION

This application claims priority to and the benefit of Korean Patent Application No. 10-2023-0187437 filed in the Korean Intellectual Property Office on Dec. 20, 2023, the entire contents of which are incorporated herein by reference.

### BACKGROUND

### 1. Technical Field

This disclosure relates to a multilayer ceramic capacitor.

### 2. Description of the Related Art

Electronic components using ceramic materials include capacitors, inductors, piezoelectric elements, varistors, or thermistors. Among these ceramic electronic components, multilayer ceramic capacitors (MLCCs) may be used in various electronic devices due to their advantages of compactness, high capacitance, and ease of mounting.

For example, multilayer ceramic capacitors may be used chip-type condensers mounted on substrates of various electronic products, such as imaging devices, such as liquid crystal displays (LCD), plasma display panels (PDP), and organic light-emitting diodes (OLED), computers, and personal portable terminals, and smartphones and charge or discharge electricity.

The multilayer ceramic capacitor may include internal electrodes disposed inside a ceramic body and external electrodes disposed outside the ceramic body and connected to the internal electrodes. There may be cases in which the external electrodes include an electrode layer and a conductive resin layer covering the electrode layer. If bending strength of the external electrodes is not sufficient or if the plating layer is not properly formed on the external electrodes, moisture resistance reliability may be deteriorated due to moisture penetration.

### SUMMARY

The disclosure provides a multilayer ceramic capacitor including an external electrode with improved bending strength and a well-formed plating layer.

However, the problems to be solved by the embodiments of the disclosure are not limited to the aforementioned problems and may be expanded in various ways within the scope of the technical idea included in the disclosure.

According to an embodiment, a multilayer ceramic capacitor includes: a ceramic body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface; a plurality of first internal electrodes and a plurality of second internal electrodes disposed inside the ceramic body; and a first external electrode and a second external electrode disposed outside the ceramic body, wherein the first external electrode includes a first end portion disposed on the first surface and electrically connected to the plurality of first internal electrodes, a first side portion extending from the first end portion to at least one of the third surface, the fourth surface, the fifth surface, and the sixth surface, and a first conductive resin layer covering at least a portion of the first side portion, wherein the second external electrode includes a second end portion disposed on the second surface and electrically connected to the plurality of second internal electrodes, a second side portion extending from the second end portion to at least one of the third surface, the fourth surface, the fifth surface, and the sixth surface, and a second conductive resin layer covering at least a portion of the second side portion, and wherein the first conductive resin layer and the second conductive resin layer include tin (Sn) and bismuth (Bi).

The first conductive resin layer may completely cover the first side portion, and the second conductive resin layer may completely cover the second side portion.

A length of the first conductive resin layer may be greater than a length of the first side portion, and a length of the second conductive resin layer may be greater than a length of the second side portion.

The first conductive resin layer may include a resin and a first conductive connection portion including an intermetallic compound, and the second conductive resin layer may include the resin and a second conductive connection portion including the intermetallic compound.

The first conductive connection portion may include tin (Sn) in an amount of 36 wt % or more and 50.4 wt % or less, and bismuth (Bi) in an amount of 14 wt % or more and 19.6 wt % or less, and the second conductive connection portion may include tin (Sn) in an amount of 36 wt % or more and 50.4 wt % or less, and bismuth (Bi) in an amount of 14 wt % or more and 19.6 wt % or less.

The intermetallic compound included in the first conductive resin layer and the intermetallic compound included in the second conductive resin layer may include at least one of Cu₆Sn₅, Cu₃Sn, Ni₃Sn, and Ag₃Sn.

The first external electrode may further include a first interface layer including an intermetallic compound and disposed between the first conductive resin layer and the first side portion, and the second external electrode may further include a second interface layer including the intermetallic compound and disposed between the second conductive resin layer and the second side portion.

The intermetallic compound included in the first interface layer and the intermetallic compound included in the second interface layer may include Cu₃Sn.

The multilayer ceramic capacitor may further include: a first plating layer covering the first external electrode and a second plating layer covering the second external electrode.

The first plating layer may include a first layer disposed on the first external electrode and a second layer disposed on the first layer, and the second plating layer may include a third layer disposed on the second external electrode and a fourth layer disposed on the third layer.

The first layer and the third layer may include nickel (Ni), and the second layer and the fourth layer may include tin (Sn).

The multilayer ceramic capacitor may further include: a third conductive resin layer discontinuously disposed between the first end portion and the first plating layer, and a fourth conductive resin layer discontinuously disposed between the second end portion and the second plating layer.

The first plating layer may directly contact the first end portion, and the second plating layer may directly contact the second end portion.

The first conductive resin layer may include a resin and a first conductive connection portion including an intermetallic compound, and the second conductive resin layer may include the resin and a second conductive connection portion including the intermetallic compound.

The first conductive connection portion may include tin (Sn) in an amount of 36 wt % or more and 50.4 wt % or less, and bismuth (Bi) in an amount of 14 wt % or more and 19.6 wt % or less, and the second conductive connection portion may include tin (Sn) in an amount of 36 wt % or more and 50.4 wt % or less, and bismuth (Bi) in an amount of 14 wt % or more and 19.6 wt % or less.

The resin may include epoxy.

The first end portion may include glass and a conductive metal.

According to the multilayer ceramic capacitor of the embodiment, moisture resistance reliability may be improved by improving the bending strength of the external electrodes and forming the desirable plating layer.

### BRIEF DESCRIPTION OF THE DRAWINGS

FIG. 1 is a perspective view schematically illustrating a multilayer ceramic capacitor according to an embodiment.

FIG. 2 is a cross-sectional view taken along line II-II′ in FIG. 1.

FIG. 3 is an exploded perspective view illustrating a stack structure of internal electrodes in the multilayer ceramic capacitor of FIG. 1.

FIG. 4 is a diagram schematically illustrating region A in FIG. 2.

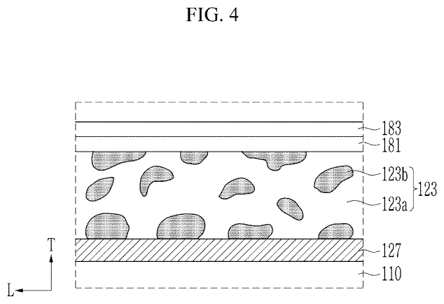

FIG. 5 is a diagram schematically illustrating region A according to another embodiment.

FIG. 6 is a diagram schematically illustrating region A according to another embodiment.

FIG. 7 is a cross-sectional view schematically illustrating a multilayer ceramic capacitor according to another embodiment.

FIG. 8 is a graph comparing equivalent series resistance (ESR) of a multilayer ceramic capacitor according to an example and a multilayer ceramic capacitor according to a comparative example.

FIG. 9 is a diagram illustrating a bending test method of a multilayer ceramic capacitor.

FIG. 10A is an X-ray photograph confirming whether lifting occurs after reflow of a multilayer ceramic capacitor according to an example.

FIG. 10B is an X-ray photograph confirming whether lifting occurs after reflow of a multilayer ceramic capacitor according to a comparative example.

### DETAILED DESCRIPTION

Hereinafter, embodiments of the disclosure will now be described more fully hereinafter with reference to the accompanying drawings so that they may be easily implemented by one of ordinary skill in the art. Portions unrelated to the description may be omitted in order to more clearly describe the disclosure, and the same or similar components may be denoted by the same reference numerals throughout the present specification. In the accompanying drawings, some of the elements in the accompanying drawings are exaggerated, omitted, or schematically illustrated, and the size of each element does not entirely reflect the actual size.

The accompanying drawings of the disclosure aim to facilitate understanding of the disclosure and should not be construed as limited to the accompanying drawings. Also, the disclosure is not limited to a specific disclosed form, but includes all modifications, equivalents, and substitutions without departing from the scope and spirit of the disclosure.

It will be understood that, although the terms first, second, etc. may be used herein to describe various elements, these elements should not be limited by these terms. These terms are only used to distinguish one element from another.

Further, it will be understood that when an element, such as a layer, film, region, or substrate is referred to as being “above” or “on” another element, it may be “directly above” the other element, or intervening elements may also be present. In contrast, when an element is referred to as being “directly on” another element, there are no intervening elements present. Further, when an element is “above” or “on” the reference portion, it may mean that the element is positioned above or below the reference portion, and it may not necessarily mean that the element is “above” or “on” toward an opposite direction of gravity.

Throughout the specification, the terms, such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded. Therefore, unless explicitly described to the contrary, the word “comprise” will be understood to imply the further inclusion of other elements but not the exclusion of them.

Throughout the specification, when it is referred to “in plan view”, it means that a target element is viewed from above, and when it is referred to “in cross-sectional view”, it means that a target element taken vertically is viewed from the side.

In addition, throughout the specification, when “connected”, it may not only mean that two or more components are directly connected, but also that two or more components are indirectly connected through other components, physically connected, and electrically connected, or integrated although they are designated by different names depending on position or function.

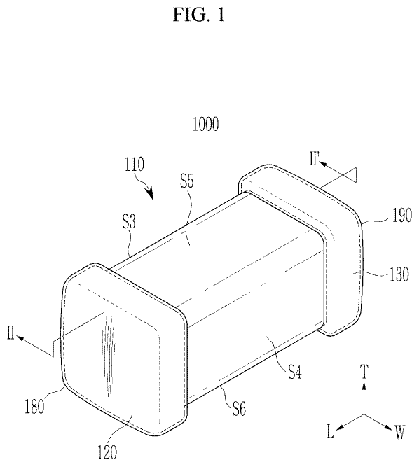

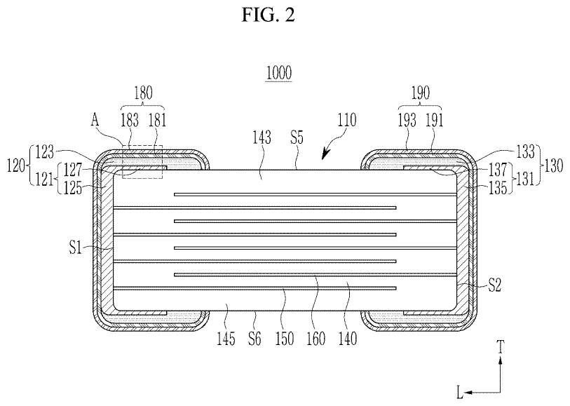

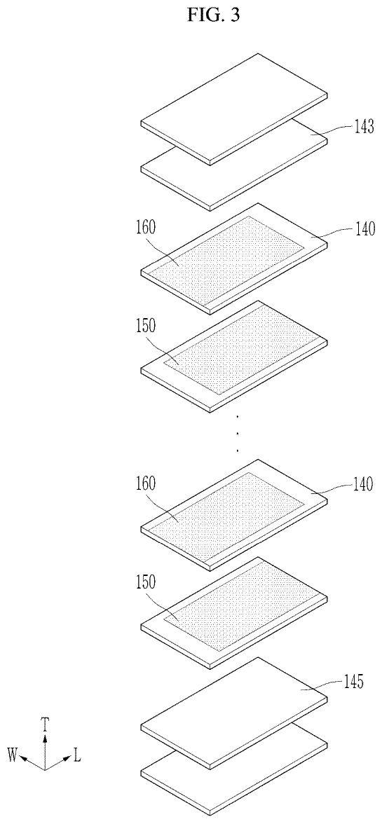

FIG. 1 is a perspective view schematically illustrating a multilayer ceramic capacitor according to an embodiment, FIG. 2 is a cross-sectional view taken along line II-II′ of FIG. 1, and FIG. 3 is an exploded perspective view illustrating a stack structure of internal electrodes in the multilayer ceramic capacitor of FIG. 1.

Referring to FIGS. 1, 2, and 3, a multilayer ceramic capacitor 1000 according to the present embodiment includes a ceramic body 110, a first external electrode 120, a second external electrode 130, and a plurality of first internal electrodes 150 and a plurality of second internal electrodes 160.

First, when the directions are defined to clearly describe the present embodiment, the L-axis, W-axis, and T-axis shown in the drawings indicate axes representing a length direction, a width direction, and a thickness direction of the multilayer ceramic capacitor 1000, respectively.

The thickness direction (a T-axis direction) may be a direction perpendicular to a large surface (a main surface) of the sheet-shaped components. For example, the thickness direction (the T-axis direction) may be used as the same concept as a direction in which a dielectric layer 140 is stacked.

The length direction (an L-axis direction) is a direction parallel to the large surface (the main surface) of the sheet-shaped components and may be a direction that intersects (or is perpendicular to) the thickness direction (the T-axis direction). For example, the length direction (the L-axis direction) may be a direction in which the first external electrode 120 and the second external electrode 130 face each other.

The width direction (a W-axis direction) is a direction parallel to the large surface (the main surface) of sheet-shaped components and may be a direction that intersects (or is perpendicular to) the thickness direction (the T-axis direction) and the length direction (the L-axis direction) at the same time.

The ceramic body 110 may have a substantially hexahedral shape, but the present embodiment is not limited thereto. Due to shrinkage during sintering, the ceramic body 110 may not have a completely hexahedral shape but may have a substantially hexahedral shape. For example, the ceramic body 110 may have a substantially rectangular parallelepiped shape, but portions corresponding to corners or vertices may have a round shape.

In the present embodiment, for convenience of description, surfaces facing each other in the length direction (the L-axis direction) are defined as a first surface S1 and a second surface S2, surfaces facing each other in the width direction (the W-axis direction) and connecting the first surface S1 and the second surface S2 are defined as a third surface S3 and a fourth surface S4, and surfaces facing each other in the thickness direction (the T-axis direction) and connecting the surface S1 and the second surface S2 are defined as a fifth surface S5 and a sixth surface S6.

Accordingly, a first direction in which the first surface S1 and the second surface S2 face each other may be the length direction (the L-axis direction), and second and third directions that are perpendicular to the first direction and that are perpendicular to each other may be the thickness direction (the T-axis direction) and the width direction (the W-axis direction) or may be the width direction (the W-axis direction) and the thickness direction (the T-axis direction), respectively.

Based on a photograph of an optical microscope or a scanning electron microscope (SEM) for a cross-section of the ceramic body 110 in the length direction (the L-axis direction)-thickness direction (the T-axis direction) at the center of the ceramic body 110 in the width direction (the W-axis direction), a length of the ceramic body 110 may refer to a maximum value among lengths of a plurality of line segments parallel to the length direction (the L-axis direction) when two outermost border lines facing each other in the length direction (the L-axis direction) of the ceramic body 110 shown on the photograph are connected. Meanwhile, the length of the ceramic body 110 may refer to a minimum value among the lengths of the plurality of line segments parallel to the length direction (the L-axis direction) when two outermost border lines facing each other in the length direction (the L-axis direction) of the ceramic body 110 shown on the photograph are connected. On the other hand, the length of the ceramic body 110 may refer to an arithmetic average value of the lengths of at least two line segments among the plurality of line segments parallel to the length direction (the L-axis direction) when two outermost border lines facing each other in the length direction (the L-axis direction) of the ceramic body 110 shown on the photograph are connected.

Based on a photograph of an optical microscope or a scanning electron microscope (SEM) for a cross-section of the ceramic body 110 in the length direction (the L-axis direction)-thickness direction (the T-axis direction) at the center of the ceramic body 110 in the width direction (the W-axis direction), a thickness of the ceramic body 110 may refer to a maximum value among lengths of a plurality of line segments parallel to the thickness direction (the T-axis direction) when two outermost border lines facing each other in the thickness direction (the T-axis direction) of the ceramic body 110 shown on the photograph are connected. Meanwhile, the thickness of the ceramic body 110 may refer to a minimum value among the lengths of the plurality of line segments parallel to the thickness direction (the T-axis direction) when two outermost border lines facing each other in the thickness direction (the T-axis direction) of the ceramic body 110 shown on the photograph are connected. On the other hand, the thickness of the ceramic body 110 may refer to an arithmetic average value of the lengths of at least two line segments among the plurality of line segments parallel to the thickness direction (the T-axis direction) when two outermost border lines facing each other in the thickness direction (the T-axis direction) of the ceramic body 110 shown on the photograph are connected.

Based on a photograph of an optical microscope or a scanning electron microscope (SEM) for a cross-section of the ceramic body 110 in the length direction (the L-axis direction)-width direction (the W-axis direction) at the center of the ceramic body 110 in the thickness direction (the T-axis direction), a width of the ceramic body 110 may refer to a maximum value among lengths of a plurality of line segments parallel to the width direction (the W-axis direction) when two outermost border lines facing each other in the width direction (the W-axis direction) of the ceramic body 110 shown on the photograph are connected.

Meanwhile, the width of the ceramic body 110 may refer to a minimum value among the lengths of the plurality of line segments parallel to the width direction (the W-axis direction) when two outermost border lines facing each other in the width direction (the W-axis direction) of the ceramic body 110 shown on the photograph are connected. On the other hand, the width of the ceramic body 110 may refer to an arithmetic average value of the lengths of at least two line segments among the plurality of line segments parallel to the width direction (the W-axis direction) when two outermost border lines facing each other in the width direction (the W-axis direction) of the ceramic body 110 shown on the photograph are connected.

The ceramic body 110 may include a plurality of dielectric layers 140 stacked in the thickness direction (the T-axis direction). The boundaries between the dielectric layers 140 may be inapparent. For example, boundaries between the dielectric layers 140 may not be readily apparent without using a scanning electron microscope (SEM), and the plurality of dielectric layers 140 may appear as an integrated structure.

The first internal electrode 150 and the second internal electrode 160 may be alternately stacked with the dielectric layer 140 interposed therebetween. The stacked structure may be repeated within the ceramic body 110, and the internal electrode closest to the fifth surface S5 of the ceramic body 110 may be the first internal electrode 150 or the second internal electrode 160, and the internal electrode closest to the sixth surface S6 may be the first internal electrode 150 or the second internal electrode 160.

The first internal electrode 150 and the second internal electrode 160 have different polarities and may be electrically insulated from each other by the dielectric layer 140 disposed therebetween.

The first internal electrode 150 and the second internal electrode 160 may be arranged to be offset from each other in the length direction (the L-axis direction) with the dielectric layer 140 interposed therebetween. One end of the first internal electrode 150 may be exposed through the first surface S1 of the ceramic body 110, and one end of the second internal electrode 160 may be exposed through the second surface S2 of the ceramic body 110. An end of the first internal electrode 150 exposed from the first surface S1 of the ceramic body 110 may be connected to the first external electrode 120. An end of the second internal electrode 160 exposed from the second surface S2 of the ceramic body 110 may be connected to the second external electrode 130.

The first internal electrode 150 and the second internal electrode 160 may be formed by printing a conductive paste including a conductive metal on a surface of the dielectric layer 140. For example, the internal electrode may be formed by printing a conductive paste including nickel (Ni) or a nickel (Ni) alloy on the surface of the dielectric layer using screen printing or gravure printing. However, the present embodiment is not limited to this.

For example, an average thickness of the first internal electrode 150 and the second internal electrode 160 may be approximately 0.1 μm or more and 2 μm or less.

Here, a thickness of the internal electrode may refer to an average thickness of one internal electrode disposed between two dielectric layers. Based on a photograph of a scanning electron microscope (SEM) at a magnification of 10,000 for a cross-section of the ceramic body 110 in the length direction (the L-axis direction)-thickness direction (the T-axis direction) at the center of the ceramic body 110 in the width direction (the W-axis direction), the average thickness of the internal electrode may be an arithmetic average value of thickness measured from 30 equally spaced points on one internal electrode along the length direction (the L-axis direction) shown in the photograph of the cross-section described above. The aforementioned 30 points may be designated in an active region described below. The average thickness of the internal electrodes may be further generalized by measuring the average thickness of each of the ten internal electrodes in this manner and then deriving an arithmetic average value of the measured values.

When voltage is applied to the first external electrode 120 and the second external electrode 130, charges are accumulated between the first internal electrode 150 and the second internal electrode 160 that face each other. That is, capacitance may be obtained between the first internal electrode 150 electrically connected to the first external electrode 120 and the second internal electrode 160 electrically connected to the second external electrode 130. Capacitance of the multilayer ceramic capacitor 1000 is proportional to an overlapping region of the first internal electrode 150 and the second internal electrode 160 that overlap each other in the thickness direction (the T-axis direction).

In other words, the multilayer ceramic capacitor 1000 may include an active region and a margin region. The active region may refer to a region in which the first internal electrode 150 and the second internal electrode 160 overlap in the thickness direction (the T-axis direction), and the margin region may refer to a region between the active region and the first surface S1 of the ceramic body 110 and a region between the active region and the second surface S2 of the ceramic body 110.

A first cover layer 143 and a second cover layer 145 may be disposed outside the active region in the thickness direction (the T-axis direction).

The first cover layer 143 is disposed between the sixth surface S6 of the ceramic body 110 and the internal electrode closest thereto. The second cover layer 145 is disposed between the fifth surface S5 of the ceramic body 110 and the internal electrode closest thereto.

That is, the first cover layer 143 may be disposed on the uppermost internal electrode within the ceramic body 110, and the second cover layer 145 may be disposed below the lowermost internal electrode. The first cover layer 143 and the second cover layer 145 may have the same composition as that of the dielectric layer 140. The first cover layer 143 and the second cover layer 145 may be formed by stacking one or more dielectric layers on an outer surface of the uppermost internal electrode and an outer surface of the lowermost internal electrode, respectively.

The first cover layer 143 and the second cover layer 145 may serve to prevent damage to the first internal electrode 150 and the second internal electrode 160 due to physical or chemical stress.

The dielectric layer 140 may include a ceramic material having a high dielectric constant. For example, the ceramic material may include a dielectric ceramic including components, such as BaTiO₃, CaTiO₃, SrTiO₃, or CaZrO₃. In addition, these components may further include auxiliary components, such as manganese (Mn) compounds, iron (Fe) compounds, chromium (Cr) compounds, cobalt (Co) compounds, and nickel (Ni) compounds. For example, the dielectric layer may include (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃ obtained by partially dissolving calcium (Ca), zirconium (Zr), etc. in BaTiO₃, but is not limited thereto.

In addition, the dielectric layer 140 may further include one or more of a ceramic additive, an organic solvent, a plasticizer, a binder, and a dispersant. Ceramic additives may be, for example, transition metal oxides or carbides, rare earth elements, magnesium (Mg), or aluminum (Al).

For example, an average thickness of the dielectric layer 140 may be 0.1 μm to 10 μm, but is not limited thereto.

The first external electrode 120 and the second external electrode 130 are disposed outside the ceramic body 110.

The first external electrode 120 may be disposed on the first surface S1 of the ceramic body 110 and extend onto the third surface S3, the fourth surface S4, the fifth surface S5, and the sixth surface S6. The second external electrode 130 may be disposed on the second surface S2 of the ceramic body 110 and extend onto the third surface S3, the fourth surface S4, the fifth surface S5, and the sixth surface S6.

The first external electrode 120 includes a first electrode layer 121 and a first conductive resin layer 123.

The first electrode layer 121 includes a conductive metal. The first electrode layer 121 may include, for example, one or more of silver (Ag), lead (Pb), platinum (Pt), nickel (Ni), copper (Cu), and alloys thereof.

The first electrode layer 121 includes a first end portion 125 and a first side portion 127.

The first end portion 125 covers the first surface S1 of the ceramic body 110 and is electrically connected to exposed ends of the plurality of first internal electrodes 150.

The first side portion 127 extends from the first end portion 125 to cover portions of the third surface S3, fourth surface S4, fifth surface S5, and sixth surface S6 of the ceramic body 110.

The first electrode layer 121 may be a fired electrode including conductive metal and glass. The first electrode layer 121 may be formed by dipping the first surface S1 of the ceramic body 110 in a slurry including a conductive metal and glass and then firing the same. Alternatively, the first electrode layer 121 may be formed by transferring a sheet including conductive metal and glass to the ceramic body 110.

The first conductive resin layer 123 covers the first side portion 127 and covers the third surface S3, fourth surface S4, fifth surface S5, and sixth surface S6 of the ceramic body 110.

For example, the first conductive resin layer 123 may completely cover the first side portion 127.

In addition, a length of the first conductive resin layer 123 may be greater than a length of the first side portion 127. Here, the length of the first conductive resin layer 123 and the length of the first side portion 127 are measured based on a photograph of an optical microscope or a scanning electron microscope (SEM) for a cross-section of the multilayer ceramic capacitor 1000 in the length direction (the L-axis direction)-thickness direction (the T-axis direction) at the center of the ceramic body 110 in the width direction (the W-axis direction). The length of the first conductive resin layer 123 may refer to a maximum value among lengths of a plurality of line segments parallel to the length direction (the L-axis direction) when two outermost border lines facing each other in the length direction (the L-axis direction) of the first conductive resin layer 123 shown on the photograph are connected. In addition, the length of the first side portion 127 may refer to a maximum value among lengths of a plurality of line segments parallel to the length direction (the L-axis direction) when two outermost border lines facing each other in the length direction (the L-axis direction) of the first side portion 127 shown on the photograph are connected. Other methods and/or tools appreciated by one of ordinary skill in the art, even if not described in the present disclosure, may also be used.

The first conductive resin layer 123 may include a first conductive connection portion 123a including an intermetallic compound and a resin 123b. The resin 123b included in the first conductive resin layer 123 may be, for example, various known thermosetting resins, such as epoxy resin, phenol resin, urethane resin, silicone resin, and polyimide resin.

Meanwhile, the first conductive resin layer 123 may include a conductive metal as a filler. For example, the filler may include copper (Cu), silver (Ag), nickel (Ni), tin (Sn), or alloys thereof.

An intermetallic compound refers to any of a class of substances composed of definite proportions of two or more elemental metals. The intermetallic compound may be formed as at least one of copper (Cu), silver (Ag), copper (Cu) coated with silver (Ag), and copper (Cu) coated with tin (Sn), and nickel (Ni), which are high melting point metals included in a conductive resin composition forming the first conductive resin layer 123 interacts with tin (Sn), tin (Sn) alloy, bismuth (Bi) or bismuth (Bi) alloy, which are low melting point metals. The intermetallic compound formed in this manner may include at least one of Cu₆Sn₅, Cu₃Sn, Ni₃Sn, and Ag₃Sn. The intermetallic compound may be identified using energy dispersive x-ray spectroscopy (EDAX) elemental analysis. Other methods and/or tools appreciated by one of ordinary skill in the art, even if not described in the present disclosure, may also be used.

Bismuth (Bi) does not directly form intermetallic compounds, but may serve to lower a melting point of tin (Sn) during the intermetallic compound formation process. In other words, as the content of bismuth (Bi) increases, the melting point of tin (Sn) may decrease. Meanwhile, the low melting point metal and the intermetallic compound remaining after forming the intermetallic compound may be included in the first conductive connection portion 123a. That is, the first conductive connection portion 123a may include a low melting point metal having a melting point lower than a curing temperature of the resin 123b. For example, a low melting point metal may have a melting point of 300° C. or lower, and more specifically, a melting point of 200° C. to 250° C.

In addition, the first conductive connection portion 123a may include, based on a total weight of the metals in the first conductive connection portion, tin (Sn) in an amount of 36 wt % to 50.4 wt % and bismuth (Bi) in an amount of 14 wt % to 19.6 wt %. The remainder may be copper (Cu), for example.

If the tin (Sn) content is less than 36 wt % and the bismuth (Bi) content is less than 14 wt % or if the tin (Sn) content is more than 50.4 wt % and the bismuth (Bi) content is more than 19.6 wt %, the intermetallic compound may not be sufficiently formed or the connectivity of the intermetallic compound may be low and the plating layer may be formed insufficiently. For example, plating breakage may occur.

Here, the content of tin (Sn) and bismuth (Bi) may be checked through energy dispersive x-ray spectroscopy (EDAX) elemental analysis. Other methods and/or tools appreciated by one of ordinary skill in the art, even if not described in the present disclosure, may also be used.

After the first electrode layer 121 is formed, a conductive resin composition including metal powder and a thermosetting resin may be applied on the first electrode layer 121. Here, the thermosetting resin may be a bisphenol A resin, glycol epoxy resin, Novolac epoxy resin, or a resin which has a low molecular weight and is liquid at room temperature among derivatives thereof, but is not limited thereto. For example, the conductive resin composition may be prepared by mixing silver (Ag) powder, copper (Cu) powder, silver (Ag)-coated copper (Cu) powder, tin (Sn)-based solder powder, and thermosetting resin and then dispersing the mixture using a 3-roll mill. The tin (Sn)-based solder powder may include at least one of tin (Sn), Sn_{96.5}Ag_{3.0}Cu_{0.5}, Sn₄₂Bi₅₈, and Sn₇₂Bi₂₈, but the disclosure is not limited thereto. Thereafter, the conductive resin composition on the first end portion 125 may be removed, and then, the first conductive resin layer 123 is formed on the first side portion 127 through curing. Accordingly, the first end portion 125 may be disposed on the first surface S1 of the ceramic body 110, and the first side portion 127 and the first conductive resin layer 123 may be disposed on the third surface S3, fourth surface S4, fifth surface S5, and sixth surface S6.

Unlike the present embodiment, if both the electrode layer and the resin layer covering the electrode layer are disposed on the first surface S1 of the ceramic body 110, the resin layer has lower electrical connectivity than the electrode layer, so equivalent series resistance (ESR) of the first external electrode may increase. There is also a risk of lifting due to out-gassing from the resin layer during a high-temperature reflow process. Furthermore, since the resin layer is present on the electrode layer, the external electrode may be thick and a relative volume of the ceramic body may be small compared to a case in which only the electrode layer is present, resulting in that effective capacity of the multilayer ceramic capacitor is reduced.

On the other hand, according to the present embodiment, the first end portion 125 is disposed on the first surface S1 of the ceramic body 110 and the first side portion 127 and the first conductive resin layer 123 are disposed on the first surface S1 of the ceramic body 110, and thus, the aforementioned problem may not occur.

The second external electrode 130 includes a second electrode layer 131 and a second conductive resin layer 133.

The second electrode layer 131 includes conductive metal. The second electrode layer 131 may include, for example, one or more of silver (Ag), lead (Pb), platinum (Pt), nickel (Ni), copper (Cu), and alloys thereof.

The second electrode layer 131 includes a second end portion 135 and a second side portion 137.

The second end portion 135 covers the second surface S2 of the ceramic body 110 and is electrically connected to the exposed ends of the plurality of second internal electrodes 160.

The second side portion 137 extends from the second end portion 135 to cover portions of the third surface S3, fourth surface S4, fifth surface S5, and sixth surface S6 of the ceramic body 110.

The second conductive resin layer 133 covers the second side portion 137 and covers portions of the third surface S3, fourth surface S4, fifth surface S5, and sixth surface S6 of the ceramic body 110.

Since the second external electrode 130 corresponds to the structure, material, and function of the first external electrode 120 except for its location, redundant descriptions thereof are omitted.

Meanwhile, the multilayer ceramic capacitor 1000 may further include a first plating layer 180 and a second plating layer 190.

The first plating layer 180 covers the first external electrode 120. The first plating layer 180 may include a first layer 181 and a second layer 183. The first layer 181 may be disposed on the first external electrode 120 and the second layer 183 may be disposed on the first layer 181. The first layer 181 may include nickel (Ni) and the second layer 183 may include tin (Sn), but the present embodiment is not limited thereto.

The second plating layer 190 covers the second external electrode 130. The second plating layer 190 may include a first layer 191 and a second layer 193. The first layer 191 may be disposed on the second external electrode 130 and the second layer 193 may be disposed on the first layer 191. The first layer 191 may include nickel (Ni) and the second layer 193 may include tin (Sn), but the present embodiment is not limited thereto.

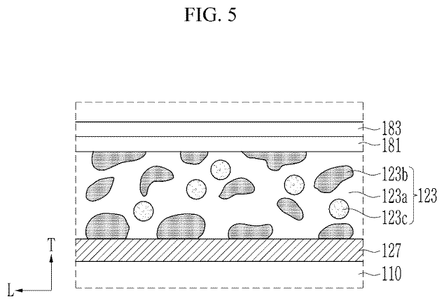

Meanwhile, FIG. 5 is a diagram schematically illustrating region A according to another embodiment.

Referring to FIG. 5, the first conductive resin layer 123 may further include a plurality of metal particles 123c. The plurality of metal particles 123c may include one or more of silver (Ag), copper (Cu), copper (Cu) coated with tin (Sn), copper (Cu) coated with silver (Ag), and nickel (Ni). The plurality of metal particles 123c may be metal particles remaining after forming an intermetallic compound by reacting with a low melting point metal having a melting point lower than a curing temperature of the resin 123b in the process of curing the first conductive resin layer 123. The metal powder included in the conductive resin composition forming the first conductive resin layer 123 may mostly react with the tin (Sn)-based solder powder to form the first conductive connection portion 123a, thereby preventing lifting between the first side portion 127 and the first conductive resin layer 123.

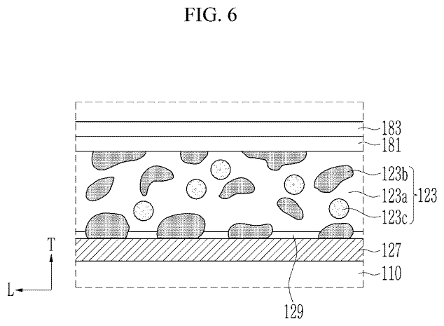

Meanwhile, FIG. 6 is a diagram schematically illustrating region A according to another embodiment.

Referring to FIG. 6, a first interface layer 129 may be disposed between the first side portion 127 and the first conductive resin layer 123. The first interface layer 129 may include an intermetallic compound. The intermetallic compound included in the first interface layer 129 may include Cu₃Sn. The first interface layer 129 may be formed by reacting copper (Cu) included in the first electrode layer 121 with tin (Sn) or tin (Sn) alloy included in the first conductive resin layer 123 in the process of forming the first conductive resin layer 123 by applying, drying and curing a conductive resin composition, but the disclosure is not limited thereto.

The first interface layer 129 may connect the first side portion 127 and the first conductive connection portion 123a of the first conductive resin layer 123. The first interface layer 129 may ensure excellent mechanical and electrical connectivity between the first side portion 127 and the first conductive resin layer 123. For example, the first interface layer 129 may be formed in the form of a plurality of islands, and the plurality of islands may form a layer.

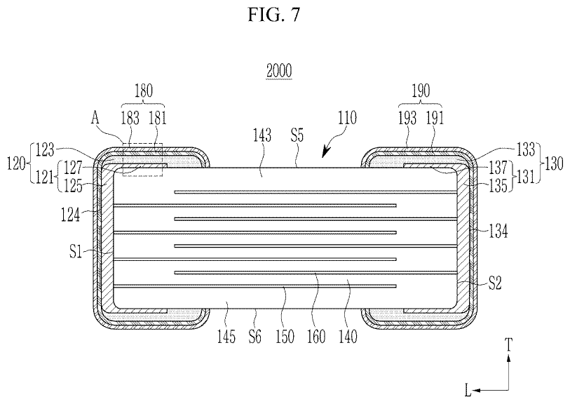

FIG. 7 is a cross-sectional view schematically illustrating a multilayer ceramic capacitor according to another embodiment.

Referring to FIG. 7, a multilayer ceramic capacitor 2000 may include a third conductive resin layer 124 and a fourth conductive resin layer 134. The third conductive resin layer 124 may be discontinuously disposed between the first end portion 125 of the first electrode layer 121 and the first plating layer 180, and the fourth conductive resin layer 134 may be discontinuously disposed between the second end portion 135 of the second electrode layer 131 and the second plating layer 190. The third conductive resin layer 124 and the fourth conductive resin layer 134 may be arranged in the form of a plurality of islands.

As described in relation to the multilayer ceramic capacitor shown in FIG. 1, after the conductive resin composition applied to the first end portion 125 and the second end portion 135 is removed, the first conductive resin layer 123 on the first side portion 127 and the second conductive resin layer 133 on the second side portion 137 are formed through curing. If the conductive resin composition on the first end portion 125 and the second end portion 135 is not completely removed, the conductive resin composition may be cured to form the third conductive resin layer 124 and the fourth conductive resin layer 134.

Since the third conductive resin layer 124 is discontinuously disposed, the first end portion 125 of the first electrode layer 121 and the first layer 181 of the first plating layer 180 may also be in discontinuous contact. Since the fourth conductive resin layer 134 is discontinuously disposed, the second end portion 135 of the second electrode layer 131 and the first layer 191 of the second plating layer 190 may also be in discontinuous contact.

Except for the above, the remaining components are the same as those of the multilayer ceramic capacitor shown in FIG. 1, so redundant descriptions thereof are omitted.

Hereinbelow, specific examples of the disclosure are presented. However, the examples described below are only for illustrating or explaining the disclosure in detail, and the scope of the disclosure should not be limited.

### Preparation Example 1: Manufacture of Multilayer Ceramic Capacitor

A paste including barium titanate (BaTiO₃) powder was applied on a carrier film and dried to manufacture a plurality of dielectric green sheets.

A conductive paste including nickel (Ni) was applied on the dielectric green sheet using screen printing to form a conductive paste layer.

A plurality of dielectric green sheets was stacked such that at least portions of the conductive paste layers overlap each other, to manufacture a dielectric green sheet stack.

After cutting the dielectric green sheet stack into individual chips, debinding was performed by maintaining the individual chips at 350° C. for 66 hours in an air atmosphere, and firing was performed at 1165° C. to manufacture a ceramic body.

A paste including a glass frit and copper (Cu) was applied to an outer surface of the ceramic body by dipping, dried, and then fired to form an electrode layer.

The ceramic body was dipped into a conductive resin composition including epoxy resin, tin (Sn), bismuth (Bi), and copper (Cu). Here, the contents of tin (Sn), bismuth (Bi), and copper (Cu) in the conductive resin layer of the external electrode of the examples and comparative examples were adjusted as shown in Table 1.

The conductive resin composition was removed from the first and second surfaces of the ceramic body using a porous non-woven fabric, and then cured to form a conductive resin layer.

Thereafter, nickel (Ni) and tin (Sn) plating was performed, and heat treatment was performed at 160° C. for 1 hour to manufacture a multilayer ceramic capacitor.

TABLE 1

| | Comparative | Comparative | Comparative | Comparative | | | | Comparative | Comparative |
|---|---|---|---|---|---|---|---|---|---|
| | Example 1 | Example 2 | Example 3 | Example 4 | Example 1 | Example 2 | Example 3 | Example 5 | Example 6 |
| Tin (Sn) | 7.2 | 14.4 | 21.6 | 28.8 | 36 | 43.2 | 50.4 | 57.6 | 64.8 |
| Bismuth | 2.8 | 5.6 | 8.4 | 11.2 | 14 | 16.8 | 19.6 | 22.4 | 25.2 |
| (Bi) | | | | | | | | | |
| Copper | 90 | 80 | 70 | 60 | 50 | 40 | 30 | 20 | 10 |
| (Cu) | | | | | | | | | |

(unit: wt %)

### Experimental Example 1

The plating breakage was determined as follows. After chemically peeling off the tin (Sn) plating layer from the Ni/Sn plating layer of the multilayer ceramic capacitor, an SEM image of the exterior of the multilayer ceramic capacitor was observed so that the nickel (Ni) plating layer on both sides of the multilayer ceramic capacitor in the length direction (L-axis direction) and the surface of the ceramic body between the Ni plating layers were simultaneously visible. In the above SEM image, the coverage of the Ni plating layer on the edges opposing each other in the direction perpendicular to the length direction (L-axis direction) of the multilayer ceramic capacitor was observed. In each of the four edges, it was determined that “plating breakage” occurred at the edge where the external electrode or ceramic body was exposed due to insufficient Ni plating layer formation. In particular, if the length of the section where the plating breakage occurred was 25% or more of the length of the edge, it was considered defective.

The defect occurrence rate due to plating breakage of the external electrode of the multilayer ceramic capacitors manufactured in the examples and comparative examples was checked, and the results are shown in Table 2.

TABLE 2

| | Comparative | Comparative | Comparative | Comparative | | | | Comparative | Comparative |
|---|---|---|---|---|---|---|---|---|---|
| | Example 1 | Example 2 | Example 3 | Example 4 | Example 1 | Example 2 | Example 3 | Example 5 | Example 6 |
| Defect | 31 | 21 | 14 | 8 | 0 | 0 | 0 | 5 | 7 |
| rate | | | | | | | | | |

(unit: %)

Referring to Table 2, no plating breakage occurred in the multilayer ceramic capacitor according to Examples 1 to 3, but in the multilayer ceramic capacitor according to Comparative Examples 1 to 6, the plating breakage occurred by 5% to 31%. That is, 31 samples out of the 100 samples according to Comparative Example 1, 21 samples out of the 100 samples according to Comparative Example 2, 14 samples out of the 100 samples according to Comparative Example 3, 8 samples out of the 100 samples according to Comparative Example 4, 5 samples out of the 100 samples according to Comparative Example 5, and 7 samples out of the 100 samples according to Comparative Example 6 each exhibited plating breakage. This is because more intermetallic compounds were formed and the intermetallic compounds had excellent connectivity in Examples, compared to Comparative Examples.

### Preparation Example 2: Manufacture of Multilayer Ceramic Capacitor

### Example 4

A multilayer ceramic capacitor was manufactured according to Preparation Example 1, but the contents of tin (Sn), bismuth (Bi), and copper (Cu) were the same as those of Example 1.

### Comparative Example 7

A paste including barium titanate (BaTiO₃) powder was applied on a carrier film and dried to manufacture a plurality of dielectric green sheets.

A conductive paste including nickel (Ni) was applied on the dielectric green sheet using screen printing to form a conductive paste layer.

A plurality of dielectric green sheets was stacked such that at least portions of the conductive paste layers overlap each other, to manufacture a dielectric green sheet stack.

After cutting the dielectric green sheet stack into individual chips, debinding was performed by maintaining the individual chips at 350° C. for 66 hours in an air atmosphere, and firing was performed at 1165° C. to manufacture a ceramic body.

A paste including a glass frit and copper (Cu) was applied to an outer surface of the ceramic body by dipping, dried, and then fired to form an electrode layer.

The ceramic body was dipped into a conductive resin composition including epoxy resin, tin (Sn), bismuth (Bi), and copper (Cu). Here, the contents of tin (Sn), bismuth (Bi), and copper (Cu) were adjusted to be the same as in Example 4.

The conductive resin composition was post-cured to form a conductive resin layer.

Thereafter, nickel (Ni) and tin (Sn) plating was performed to manufacture a multilayer ceramic capacitor.

### Experimental Example: Performance of Multilayer Ceramic Capacitor

### Experimental Example 2

The moisture resistance of the multilayer ceramic capacitors manufactured in Example 4 and Comparative Example 7 were measured.

Solder cream was patterned using a stencil mask on a PCB dedicated to moisture resistance characteristics of 40 channels. Thereafter, a reflow process was performed at the highest temperature of 260° C. and a prepared specimen was mounted on the PCB. The prepared PCB was mounted in a slot in which a potential difference and current may be measured and introduced into a chamber with a temperature of 85° C. and a humidity of 60% RH. Thereafter, in a first of 1 hour and a second step of 1 hour in which a potential difference of 7.56 V was applied to both ends of the specimen and a third step of 2 hours in which a potential difference of 4.5 V was applied to both ends of the specimen, the level of deterioration in insulation resistance (IR) was checked to measure moisture resistance, and results thereof are shown in Table 3.

TABLE 3

| | Temperature | Potential | | | Insulation resistance (IR) (Ω) | |
|---|---|---|---|---|---|---|
| Step | (° C.) | difference(V) | Time | Humidity (%) | Example | Comparative Example |
| 1 | 40 | 7.56 | 1 | 60 | — | — |
| 2 | 85 | 7.56 | 1 | 60 | — | — |
| 3 | 85 | 4.5 | 2 | 60 | 10⁹ | 10⁷ |

Referring to Table 3, the insulation resistance of the multilayer ceramic capacitor manufactured in Comparative Example 7 dropped to 10⁷Ω in the third step, while the insulation resistance of the multilayer ceramic capacitor manufactured in Example 4 was maintained at 10⁹Ω in the third step, exhibiting excellent moisture resistance.

### Experimental Example 3

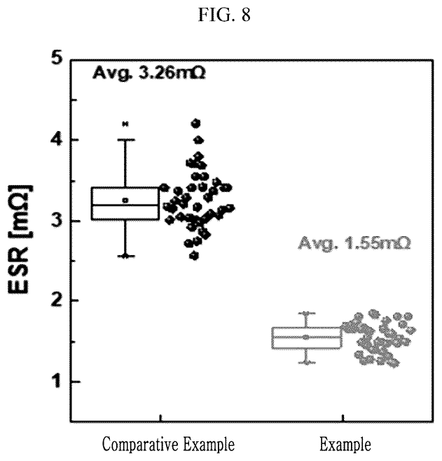

The results of measuring the equivalent series resistance of the multilayer ceramic capacitors manufactured in Example 4 and Comparative Example 7 are shown in FIG. 8.

Referring to FIG. 8, the equivalent series resistance (ESR) of the multilayer ceramic capacitor manufactured according to Example 4 is 1.55 mΩ on average, and the equivalent series resistance (ESR) of the multilayer ceramic capacitor manufactured according to Comparative Example 7 is 3.26 mΩ on average. That is, the equivalent series resistance of Example 4 is lower than that of Comparative Example 7. This is because electrical connectivity was improved by forming a plating layer directly on the electrode layers on the first and second surfaces of the ceramic body without disposing a resin layer.

### Experimental Example 4

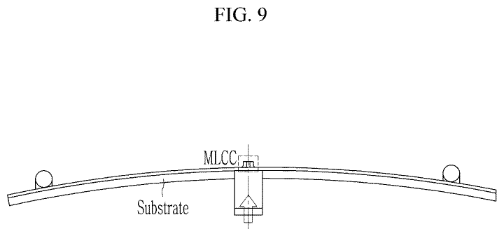

The frequency of crack occurrence in the ceramic bodies of the multilayer ceramic capacitors manufactured according to Example 4 and Comparative Example 7 was tested using a bending test method shown in FIG. 9.

Referring to FIG. 9, the multilayer ceramic capacitor mounted on the substrate was disposed in a device that may press a mounting surface, and the side opposite to the mounting surface of the multilayer ceramic capacitor was pressed down by 3 mm to determine whether bending cracks occur and measure the frequency of crack occurrence.

In the 3 mm bending strength test, no cracks that broke the ceramic bodies occurred in Example 4 and Comparative Example 7 among the 30 samples for each of Example 4 and Comparative Example 7.

In this manner, the multilayer ceramic capacitor according to Example 4 showed bending strength equivalent to that of Comparative Example 7.

### Experimental Example 5

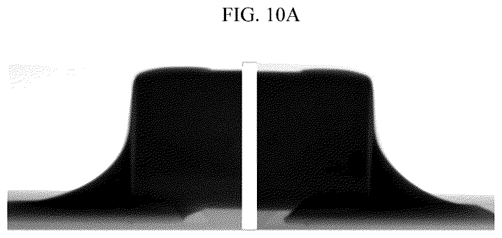

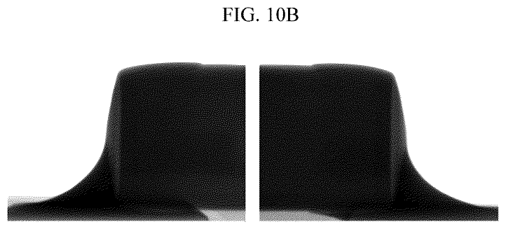

FIG. 10A is an X-ray photograph confirming whether lifting occurred after reflow of the multilayer ceramic capacitor according to Example 4, and FIG. 10B is an X-ray photograph confirming whether lifting occurred after reflow of the multilayer ceramic capacitor according to Comparative Example 7.

In Example 4 and Comparative Example 7, no lifting occurred after reflow among the 40 samples for each of Example 4 and Comparative Example 7. In this manner, the multilayer ceramic capacitor according to Example 4 showed a level equivalent to that of Comparative Example 7.

Although the embodiment of the disclosure has been described above, the disclosure is not limited thereto, and it is possible to carry out various modifications within the claim coverage, the description of the present disclosure, and the accompanying drawings, and such modifications also fall within the scope of the disclosure.

What is claimed is:

1. A multilayer ceramic capacitor comprising:
a ceramic body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
a plurality of first internal electrodes and a plurality of second internal electrodes disposed inside the ceramic body; and
a first external electrode and a second external electrode disposed outside the ceramic body,
wherein the first external electrode includes:
a first end portion disposed on the first surface and electrically connected to the plurality of first internal electrodes,
a first side portion extending from the first end portion to at least one of the third surface, the fourth surface, the fifth surface, and the sixth surface, and
a first conductive resin layer covering at least a portion of the first side portion,
wherein the second external electrode includes:
a second end portion disposed on the second surface and electrically connected to the plurality of second internal electrodes,
a second side portion extending from the second end portion to at least one of the third surface, the fourth surface, the fifth surface, and the sixth surface, and
a second conductive resin layer covering at least a portion of the second side portion, and
wherein the first conductive resin layer and the second conductive resin layer include tin (Sn) and bismuth (Bi).

2. The multilayer ceramic capacitor of claim 1, wherein:
the first conductive resin layer completely covers the first side portion, and
the second conductive resin layer completely covers the second side portion.

3. The multilayer ceramic capacitor of claim 2, wherein:
a length of the first conductive resin layer is greater than a length of the first side portion, and
a length of the second conductive resin layer is greater than a length of the second side portion.

4. The multilayer ceramic capacitor of claim 1, wherein:
the first conductive resin layer includes a resin and a first conductive connection portion including an intermetallic compound, and
the second conductive resin layer includes the resin and a second conductive connection portion including the intermetallic compound.

5. The multilayer ceramic capacitor of claim 4, wherein:
the first conductive connection portion includes:
tin (Sn) in an amount of 36 wt % or more and 50.4 wt % or less, and
bismuth (Bi) in an amount of 14 wt % or more and 19.6 wt % or less, and
the second conductive connection portion includes:
tin (Sn) in an amount of 36 wt % or more and 50.4 wt % or less, and
bismuth (Bi) in an amount of 14 wt % or more and 19.6 wt % or less.

6. The multilayer ceramic capacitor of claim 4, wherein:
the intermetallic compound included in the first conductive resin layer and the intermetallic compound included in the second conductive resin layer include at least one of Cu₆Sn₅, Cu₃Sn, Ni₃Sn, and Ag₃Sn.

7. The multilayer ceramic capacitor of claim 1, wherein:
the first external electrode further includes a first interface layer including an intermetallic compound and disposed between the first conductive resin layer and the first side portion, and
the second external electrode further includes a second interface layer including the intermetallic compound and disposed between the second conductive resin layer and the second side portion.

8. The multilayer ceramic capacitor of claim 7, wherein:
the intermetallic compound included in the first interface layer and the intermetallic compound included in the second interface layer include Cu₃Sn.

9. The multilayer ceramic capacitor of claim 1, further comprising:
a first plating layer covering the first external electrode and a second plating layer covering the second external electrode.

10. The multilayer ceramic capacitor of claim 9, wherein:
the first plating layer includes a first layer disposed on the first external electrode and a second layer disposed on the first layer, and
the second plating layer includes a third layer disposed on the second external electrode and a fourth layer disposed on the third layer.

11. The multilayer ceramic capacitor of claim 10, wherein:
the first layer and the third layer include nickel (Ni), and
the second layer and the fourth layer include tin (Sn).

12. The multilayer ceramic capacitor of claim 9, further comprising:
a third conductive resin layer discontinuously disposed between the first end portion and the first plating layer, and
a fourth conductive resin layer discontinuously disposed between the second end portion and the second plating layer.

13. The multilayer ceramic capacitor of claim 9, wherein:
the first plating layer directly contacts the first end portion, and
the second plating layer directly contacts the second end portion.

14. The multilayer ceramic capacitor of claim 13, wherein:
the first conductive resin layer includes a resin and a first conductive connection portion including an intermetallic compound, and
the second conductive resin layer includes the resin and a second conductive connection portion including the intermetallic compound.

15. The multilayer ceramic capacitor of claim 14, wherein:
the first conductive connection portion includes:
tin (Sn) in an amount of 36 wt % or more and 50.4 wt % or less, and
bismuth (Bi) in an amount of 14 wt % or more and 19.6 wt % or less.

16. The multilayer ceramic capacitor of claim 15, wherein the resin includes epoxy.

17. The multilayer ceramic capacitor of claim 16, wherein the first end portion includes glass and a conductive metal.
